(19) United States
(12) Patent Application Publication
(10) Pub. No.: US 2026/0185203 A1
(43) Pub. Date: Jul. 2, 2026

(54) POWDER PROCESSING DEVICE USING MICROWAVE TORCH PLASMA HAVING HIGH DENSITY IN EDGE AREA

(71) Applicant: KOREA INSTITUTE OF FUSION ENERGY, Daejeon (KR)

(72) Inventors: Yong Cheol HONG, Goyang-si (KR); Se Min CHUN, Gunsan-si (KR); Geon Woo YANG, Gunsan-si (KR)

(73) Assignee: KOREA INSTITUTE OF FUSION ENERGY, Daejeon (KR)

(21) Appl. No.: 18/855,902

(22) PCT Filed: May 3, 2023
(86) PCT No.: PCT/KR2023/006033

§ 371 Date: Oct. 10, 2024

(30) Foreign Application Priority Data
May 3, 2022 (KR) 10-2022-0054873

(51) Int. Cl. C23C 4/134; H05H 1/30

(52) U.S. Cl. CPC C23C 4/134; H05H 1/30; H05H 2245/42

(57) ABSTRACT

A powder treating apparatus using microwave torch plasma having a high edge area density is disclosed. The powder treating apparatus includes a microwave waveguide, wherein when a dominant mode waveguide for transmitting an electromagnetic wave of a specific frequency is a, the microwave waveguide has a width of na, where n is an integer greater than or equal to 2; a discharge tube vertically extending through the waveguide such that all of two or more peaks of an electric field distribution within the waveguide are positioned in an inner space of the discharge tube; a plasma discharge gas injection unit disposed at a side of one end in a vertical direction of the discharge tube and configured to inject the plasma discharge gas into the discharge tube; and a treatment target powder injection unit disposed at a side of the other end in the vertical direction of the discharge tube and configured to inject the treatment target powder into the discharge tube.

### BACKGROUND

### Field of the Disclosure

The present disclosure relates to a powder treating apparatus, and more particularly, relates to a powder treating apparatus that efficiently performs plasma-based treatment on powders using microwave torch plasma having a high edge area density.

### Description of Related Art

A high-density plasma process is being applied to manufacture a highly integrated semiconductor device of a size in a range of several tens of nm or smaller in semiconductor device manufacturing equipment. Therefore, functionality such as durability against plasma radical corrosion and resistance against cations are required in the semiconductor device manufacturing equipment.

Accordingly, a material that is resistant to plasma, high temperature, and chemical corrosion is coated on an inner wall of the semiconductor device manufacturing equipment in a plasma spray manner.

Yttria powders are an example of the plasma spray coated material. Yttria powders are fine powders with a particle size of 15 to 25 μm, and this spray coated material should have high flowability to form a high density and dense coating film during the plasma spray coating.

In terms of the flowability of a powder material, the electrostatic properties of the powder material have also been proven to be one of the most important factors affecting the flowability of the powders. The electrical charges on the surface of the powder particles can be obtained due to contact and relative movement between a container of an analysis device and the powders or between the powder particles. This process is referred to as tribocharging, and this phenomenon occurs due to electrons migrating from a surface of one of different materials to a surface of the other thereof when the different materials come into contact with each other. At this time, one material becomes positively charged and the other material becomes negatively charged. The material that generates the static electricity via the tribocharging has poorer flowability than the material that does not generate the static electricity. Therefore, development of a powder treating apparatus that may increase the flowability of the powders are required.

Further, a number of powder treating apparatuses for treating the powders using plasma have been developed and are being utilized.

For example, the powders are treated using microwave plasma troch apparatus as shown in FIG. 1.

Referring to FIG. 1, a plasma torch 70 may be equipped with a reactor 75 that vertically extends through a waveguide 60, and a quartz 80.

That is, the reactor 75 vertically extends through the waveguide 60, and an inner space for plasma generation is formed in the reactor. Furthermore, in order for the microwave of the waveguide 60 to be introduced into the reactor 75, a portion of the reactor in which the waveguide 60 and the reactor meet each other is opened, and the quartz 80 is disposed in the portion thereof. The quartz 80 transmits the microwave therethrough while blocking introduction of gas, and a microwave transmission area and a plasma area are defined by the quartz 80.

When treating the powders, plasma gas and reaction gas and powders to be treated are injected from a position on top of the reactor 75 into the reactor in a direction of an arrow. Thus, the powders are treated using the plasma.

However, in this conventional plasma torch 70, the waveguide 60 is TE₁₀ of a dominant mode. Accordingly, as shown in FIG. 1, the conventional plasma torch 70 exhibits an electric field distribution in which a strong electric field occurs in a central area of the reactor 75. When plasma is generated in this electric field distribution, a plasma density increases only in a central area thereof.

Therefore, when treating the powders using the conventional plasma torch 70 as shown in FIG. 1, the powder treating efficiency increases only in the central area of the plasma, thereby making it difficult to efficiently treat all of powders that are input into the reactor.

Further, since the yttria powders are currently being imported entirely from Japan, reducing a raw material consumption cost of the plasma spray coating through domestic production of the yttria powders are an urgent task that should be solved by those skilled in the relevant field.

### SUMMARY OF THE INVENTION

Therefore, a purpose that the present disclosure seeks to achieve is to provide a microwave torch plasma having the highest area density such that that the surfaces of the powders are uniformized, and the flowability of the powders is increased, and a significant portion of the powders is efficiently treated while the powders smoothly flow in a swirl direction without the powders being fixed or accumulated on an inner wall of a discharge tube.

Another purpose of the present disclosure is to provide a microwave torch plasma having the highest edge area density that may increase an amount of powders which can be treated using the apparatus.

One aspect of the present disclosure provides a powder treating apparatus using microwave torch plasma having a high edge area density, the apparatus comprising: a microwave waveguide, wherein when a dominant mode waveguide for transmitting an electromagnetic wave of a specific frequency is a, the microwave waveguide has a width of na, where n is an integer greater than or equal to 2; a discharge tube vertically extending through the waveguide such that all of two or more peaks of an electric field distribution within the waveguide are positioned in an inner space of the discharge tube; a plasma discharge gas injection unit disposed at a side of one end in a vertical direction of the discharge tube and configured to inject the plasma discharge gas into the discharge tube; and a treatment target powder injection unit disposed at a side of the other end in the vertical direction of the discharge tube and configured to inject the treatment target powder into the discharge tube.

In one embodiment, when the dominant mode waveguide for transmitting the electromagnetic wave of the specific frequency is a, the microwave waveguide has the width of na, wherein n is an integer greater than or equal to 2, wherein when the electric field distribution along a width direction of the waveguide is (2n)λ/2 where n is an integer greater than or equal to 1, the discharge tube is installed such that a longitudinal null line of the electric field distribution extends through a center of the discharge tube, and adjacent peaks of the electric field distribution are positioned in an inner space of the discharge tube.

In one embodiment, when the dominant mode waveguide for transmitting the electromagnetic wave of the specific frequency is a, the microwave waveguide has the width of na, wherein n is an integer greater than or equal to 2, wherein when the electric field distribution along a width direction of the waveguide is (2n+1)λ/2 where n is an integer greater than or equal to 1, the discharge tube is installed such that a center of the discharge tube coincides with a central peak among peaks arranged in a longitudinal direction of the waveguide of the electric field distribution.

In one embodiment, the plasma discharge gas injection unit is configured to inject the gas tangentially with respect to a cross-sectional circle of the discharge tube, so that the gas flows in a swirl manner within the discharge tube.

In one embodiment, the treatment target powder injection unit is configured to inject the powders in the same direction as the injection direction of the gas in the swirl manner.

In one embodiment, the treatment target powder injection unit is configured to inject the powders toward the peak of the electric field distribution.

In one embodiment, the treatment target powder injection unit includes at least two treatment target powder injection units, wherein the at least two treatment target powder injection units respectively inject the powders toward at least two peaks of the electric field distribution.

In one embodiment, the powder treating apparatus further include a straight gas injection unit configured to inject straight gas into the discharge tube in a direction from the plasma discharge gas injection unit to the treatment target powder injection unit along a central axis of the discharge tube.

Another aspect of the present disclosure provides a plasma spray coating apparatus including the powder treating apparatus using the plasma as described above.

Using the powder treating apparatus using the microwave torch plasma with a high edge area density according to an embodiment of the present disclosure, the surfaces of the powders may be uniformized, and the flowability of the powders may be increased, and a significant portion of the powders may be efficiently treated while the powders smoothly flow in a swirl direction, and an amount of the powders which can be treated using the apparatus may be increased.

### BRIEF DESCRIPTION OF THE DRAWINGS

FIG. 1 is a cross-sectional view showing a configuration of a conventional microwave plasma troch apparatus.

FIG. 2 is a cross-sectional view showing a configuration of a powder treating apparatus using microwave torch plasma with a high edge area density according to an embodiment of the present disclosure.

FIG. 3 is a diagram showing an example appearance of a dominant waveguide.

FIG. 4 is a diagram showing a location of a discharge tube in the dominant waveguide and a location of the discharge tube in a waveguide of the present disclosure.

FIG. 5 is a diagram showing a mode of each of the dominant waveguide and the waveguide of the present disclosure.

FIGS. 6 to 8 show a location of the discharge tube of the powder treating apparatus using microwave torch plasma with a high edge area density according to one embodiment.

FIG. 9 is a graph showing results of measuring a flowability and a tap density of yttria powders after plasma-based treatment thereon using the powder treating apparatus using microwave torch plasma having a high edge area density according to one embodiment of the present disclosure.

FIG. 10 is a diagram showing aggregation of yttria powders before plasma-based treatment thereon and aggregation of yttria powders after plasma-based treatment thereon using the powder treating apparatus using microwave torch plasma having a high edge area density according to one embodiment of the present disclosure.

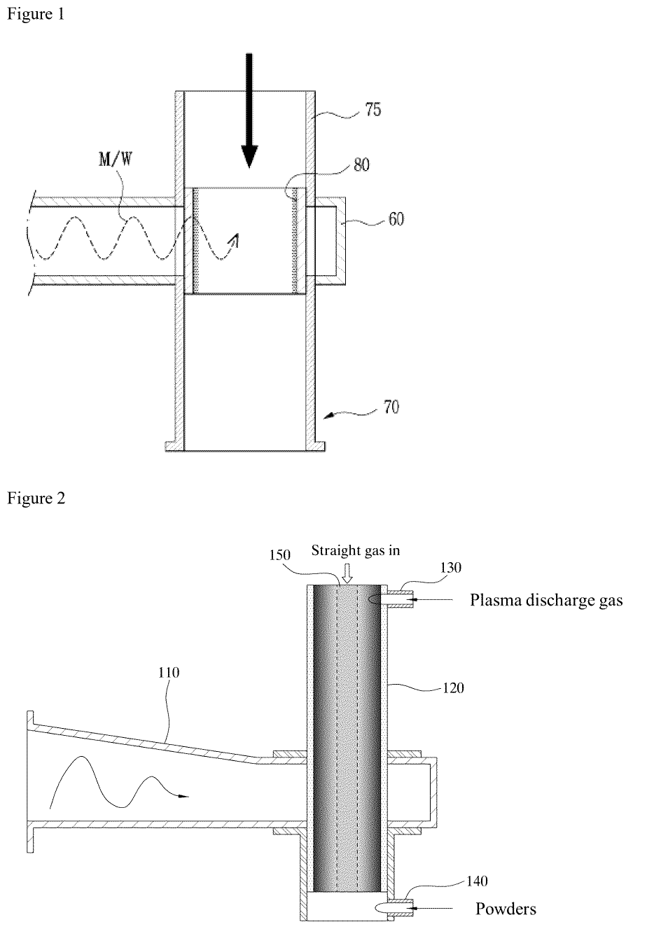

### DETAILED DESCRIPTION OF THE INVENTION

Hereinafter, the powder treating apparatus using microwave torch plasma having a high edge area density according to one embodiment of the present disclosure will be described in detail with reference to the attached drawings. The present disclosure may be modified in various ways and may have various forms. Thus, specific embodiments are illustrated in the drawings and described in detail herein. However, this is not intended to limit the present disclosure to the specific form as disclosed. Rather, it should be understood that the present discourse includes all modifications, equivalents, or substitutes that fall within the spirit and the idea of the present disclosure. In describing the drawings, similar reference numerals are used to refer to similar components. In the attached drawings, the dimensions of structures as shown are enlarged from actual sizes thereof for clarity of illustration of the present disclosure.

The terms first, second, etc. may be used to describe various components, but the components should not be limited by the terms. The terms are used only for the purpose of distinguishing one component from another component. For example, without exceeding the scope of the present disclosure, the first component may be named the second component, and similarly the second component may be named the first component.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 2 is a cross-sectional view showing a configuration of a powder treating apparatus using microwave torch plasma with a high edge area density according to an embodiment of the present disclosure, and FIG. 2 is a diagram showing an example appearance of a dominant waveguide.

Referring to FIG. 2, a powder treating apparatus using microwave torch plasma with a high edge area density according to an embodiment of the present disclosure may include a microwave waveguide 110, a discharge tube 120, a plasma discharge gas injection unit 130, and a treatment target powder injection unit 140.

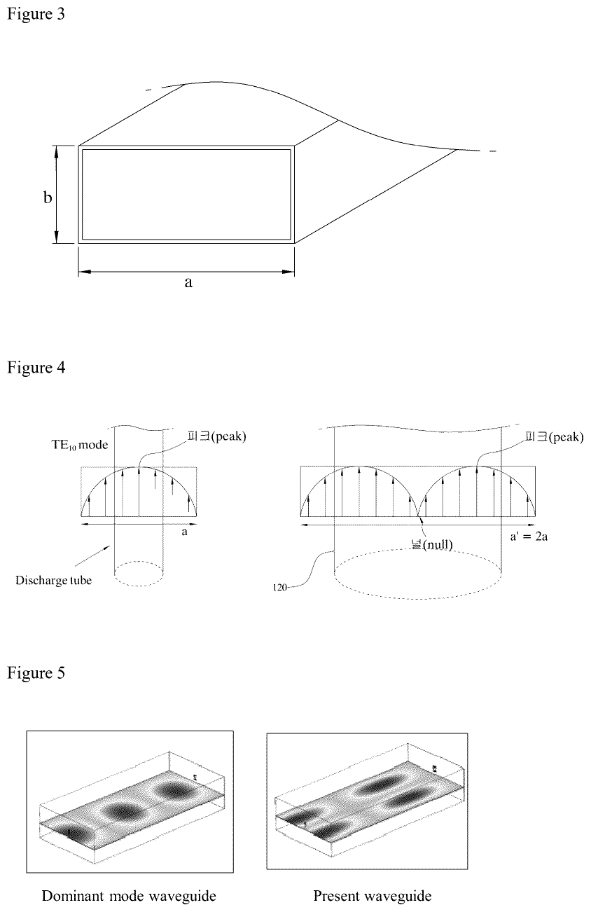

The microwave waveguide 110 is a waveguide having a width larger than that of a dominant mode waveguide for transmitting an electromagnetic wave of a specific frequency. That is, when the width of the dominant mode waveguide is a, the waveguide 110 of the present disclosure has a width of na (n is an integer greater than or equal to 2). This corresponds to the case where the width is defined as a and the height as b in the appearance of the waveguide shown in an example in FIG. 3.

The dominant mode refers to a mode in which the electromagnetic wave is propagated at a minimum degradation in a waveguide that may operate in one or more propagation modes. That is, the dominant mode is a mode with the lowest cutoff frequency. When a rectangular waveguide is manufactured, the dominant mode is TE₁₀.

The mode refers to a form in which energy of a specific frequency is concentrated in a structure. The mode in a resonator refers to a resonant frequency and a resonant form thereof. The mode in a waveguide or a transmission line refers to a form in which an electromagnetic wave of a specific frequency band travels. The mode is related to a phenomenon in which energy is concentrated at a specific frequency depending on structural characteristics. The important thing is that the mode is ultimately determined based on a shape of the structure. In order to use a specific mode, a structure should be designed so that a target frequency energy converges at the mode.

Further, the cutoff frequency of the waveguide 110 of the present disclosure may be as follows. Only frequencies higher than or equal to the cutoff frequency may be transmitted to the waveguide.

$$fcut , mn = {\frac{c}{2 π} [ {( \frac{m π}{a} )}^{2} + {( \frac{n π}{b} )}^{2} ]}^{\frac{1}{2}}$$

In this case, c is the speed of light, a and b are the width and the height of the rectangular waveguide, respectively, and n and m are mode numbers.

For example, in a TE₂₀ mode, m and a are simultaneously doubled, compared to the TE₁₀ mode. Thus, in the above equation, the cutoff frequency of the TE₁₀ mode and the cutoff frequency of the TE₂₀ mode are equal to each other. In a TE₃₀ mode, a is tripled compared to the TE₁₀ mode, and the cutoff frequency of the TE₁₀ mode and the cutoff frequency of the TE₃₀ mode are equal to each other. Therefore, even when a is increased by an integer multiple, 2.45 GHz microwave is transmitted. This may be applied to 915 GHZ, 5.8 GHZ, etc. That is, although the width of the waveguide 110 of the present disclosure is increased, the waveguide 110 of the present disclosure can transmit a microwave of a frequency determined based on the increase in the width, which is not the case for the specific waveguide of the dominant mode.

The discharge tube 120 vertically extends through the waveguide 110 so as to include two or more peaks of an electric field distribution within the waveguide 110.

Hereinafter, embodiments for increasing a density of plasma in an edge area within the discharge tube 120 in the powder treating apparatus using microwave torch plasma with a high edge area density according to the present disclosure will be specifically described.

FIG. 4 is a diagram showing a location of the discharge tube in the dominant waveguide and a location of the discharge tube in the waveguide of the present disclosure.

In an embodiment, in order to expand arc plasma jet discharged from an arc plasma generator 120, the width of the waveguide 110 of the present disclosure is increased to a′=na which is n times of a so as to be larger than the width a of the specific waveguide of the dominant mode, as shown in FIG. 4. In this case, n is an integer greater than or equal to 2. As a result, the width becomes 2a, and the electric field distribution along a width direction of the waveguide 110 becomes (2n)λ/2. In this regard, n is an integer greater than or equal to 1.

FIG. 5 is a diagram showing a mode of each of the dominant waveguide and the waveguide of the present disclosure. As shown in FIG. 5, the electric field distribution is expressed as a contour line.

The electric field distribution refers to a distribution of the E-field in which an area with the equal electric field magnitude is expressed in the same color or in a form of a contour line. A portion with the largest electric field intensity in the electric field distribution is referred to a peak, and a portion with the smallest electric field intensity is referred to as a null. The null between adjacent peaks and the null between adjacent peaks are connected to each other to form a line and this line is referred to as a null line. The null lines include a longitudinal null line extending along a length direction of the waveguide and a width directional null line extending along a direction perpendicular to the length direction of the waveguide. In this regard, the null line may mean including a line connecting a null and a null to each other and a line extending through a null between adjacent peaks.

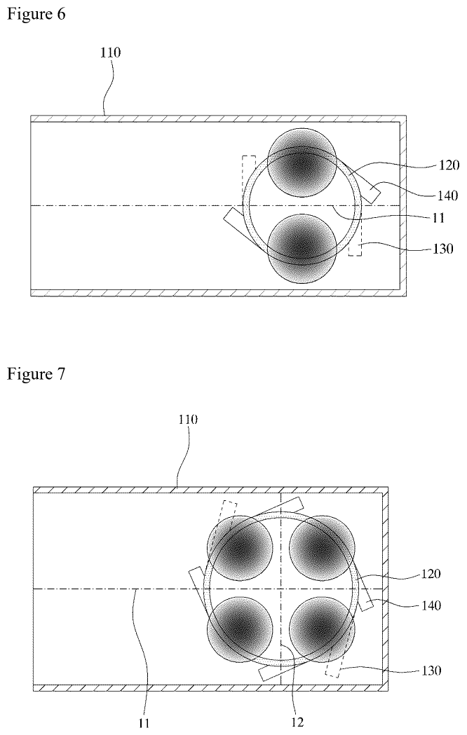

FIGS. 6 to 8 show a location of the discharge tube of the powder treating apparatus using the microwave torch plasma having the high edge area density of the present disclosure.

In the electric field distribution of the waveguide 110 with the increased width as shown in FIG. 4, the discharge tube 120 is positioned so that a longitudinal null line 11 of the electric field distribution extends through a center of the discharge tube 120, as shown in FIG. 6. In this case, adjacent peaks of the electric field distribution of (2n)λ/2 formed along the width direction of the waveguide 110, that is, peaks adjacent to each other around the null located at the center of the discharge tube 120 are located within the diameter area of the discharge tube 120. Therefore, multiple peaks having the high electric field intensity of the electric field distribution may be located in the edge area of the discharge tube 120 due to the adjacent peaks inside the discharge tube 120. Therefore, the diameter of the discharge tube 120 may be widened, and the multiple peaks with the high electric field intensity of the electric field distribution of the waveguide 110 are located within the discharge tube 120, such that the high-density microwave torch plasma may be generated in the edge area within the discharge tube 120.

Alternatively, in the electric field distribution of the waveguide 110 with an increased width as shown in FIG. 4, the discharge tube 120 of the arc plasma generator 120 is positioned so that the longitudinal null line 11 of the electric field distribution extends through the center of the discharge tube 120 and at the same time, a width-directional null line 12 of the electric field distribution extends through the center of the discharge tube 120, as shown in FIG. 7. In this case, adjacent peaks of the electric field distribution of (2n)λ/2 along the width direction of the waveguide 110, that is, a number of adjacent peaks adjacent to the longitudinal null line 11 and the width-directional null line 12 extending through the center of the discharge tube 120 are positioned within the diameter area of the discharge tube 120. Therefore, the diameter of the discharge tube 120 may be larger than that in the case of FIG. 5, such that a larger number of peaks may be located in the edge area within the discharge tube 120, and microwave torch plasma having a higher density than in the case of FIG. 5 may be generated in the edge area in the discharge tube 120.

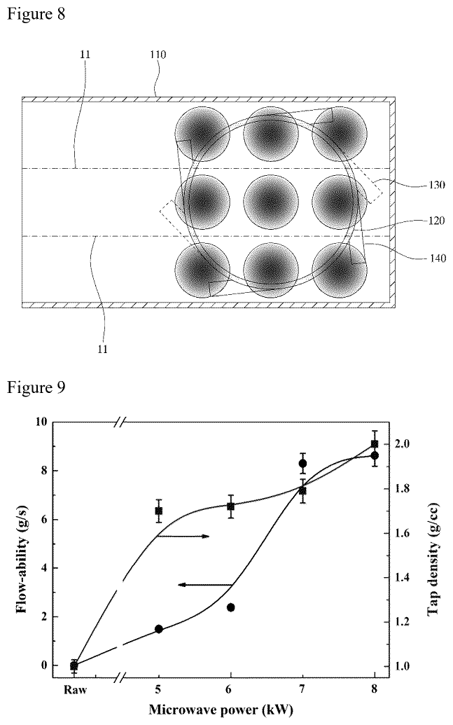

FIG. 8 shows an arrangement position of the discharge tube 120 when the width of the waveguide 110 is na (n is an integer greater than or equal to 2), and the electric field distribution along the width direction of the waveguide 110 is (2n+1)λ/2 (n is an integer greater than or equal to 1).

As shown in FIG. 8, when the discharge tube 120 is disposed across (2n+1)λ/2 of the electric field distribution, the center of the discharge tube 120 coincides with a middle peak in the width direction among the length directional peaks of the electric field distribution. In this case, the peak coinciding with the center of the discharge tube 120 and multiple peaks adjacent thereto are positioned within the diameter area of the discharge tube 120. Therefore, the diameter of the discharge tube 120 may be larger than that in each of the cases of FIG. 6 and FIG. 7. The peaks with a high electric field intensity of the electric field distribution of the waveguide 110 are located in the center and an area around the center of the discharge tube 120, i.e., the edge area of the discharge tube 120. Thus, the density of the microwave torch plasma generated within the discharge tube 120 may be increased not only in the edge area of the discharge tube 120 but also in the center area thereof.

In the arrangement structure of the discharge tube 120 according to these embodiments, the plasma discharge gas injection unit 130 for injecting plasma discharge gas into the discharge tube 120 is provided on a side of one portion of the discharge tube 120, for example, on a side of an upper portion of the discharge tube 120, and injects the plasma discharge gas into the discharge tube 120. At this time, the plasma discharge gas from the plasma discharge gas injection unit 130 is injected in a tangential manner with respect to a cross-sectional circle of the discharge tube 120, so that the injected plasma discharge gas may flow in a swirl manner within the discharge tube 120.

The treatment target powder injection unit 140 is provided on a side of the other portion of the discharge tube 120, for example, on a side of the lower portion of the discharge tube 120, and injects the powders into the discharge tube 120. At this time, the treatment target powders from the treatment target powder injection unit 140 are injected in a tangential manner with respect to a cross-sectional circle of the discharge tube 120, and are injected in the same direction as a direction as the injection direction of the plasma discharge gas such that the powders may flow in the swirl manner within the discharge tube 120. Further, the treatment target powder injection unit 140 may be positioned adjacent to the peak of the electric field positioned within the diameter area of the discharge tube 120 such that the treatment target powders may be injected toward the peak of the electric field. A downward direction from a bottom of the discharge tube 120 may be a direction in which the microwave torch plasma having the high density under the peaks is discharged.

The treatment target powder injection unit 140 may include two or more of treatment target powder injection units. In one embodiment, the number of the powder injection units 140 may be equal to the number of the peaks positioned within the diameter area of the discharge tube 120. In this case, the treatment target powder injection units 140 may be positioned adjacent to the peaks, respectively, and may inject the powders toward the peaks of the electric field, respectively.

In one example, the powder treating apparatus using microwave torch plasma with a high edge area density according to an embodiment of the present disclosure may additionally include a straight gas injection unit 150 which injects straight gas into the discharge tube 120 in a direction from the plasma discharge gas injection unit 130 to the treatment target powder injection unit 140 along a central axis of the discharge tube 120.

When the plasma discharge gas injected into the discharge tube 120 flows in the swirl form, a reverse vortex may occur in the central area of the discharge tube 120, such that the powders supplied in the swirl direction in which the plasma discharge gas flows may become stuck or accumulated on an inner wall of the discharge tube 120. However, when the straight gas is injected into the discharge tube, the reverse vortex may be prevented, thereby solving the above problem.

Hereinafter, a process of treating the powders using the powder treating apparatus using the microwave torch plasma with the high edge area density according to an embodiment of the present disclosure will be described.

The electromagnetic wave is transmitted along the microwave waveguide 110, such that multiple peaks are generated to be positioned within the diameter area of the discharge tube 120 under the electric field distribution of the waveguide 110. The plasma discharge gas is injected into the inner space of the discharge tube 120 from the plasma discharge gas injection unit 130 such that the plasma discharge gas flows in the swirl manner inside the discharge tube 120. Thus, the microwave torch plasma is discharged in the discharge direction from the discharge tube 120, for example, downwardly from the bottom of the discharge tube 120.

At this time, the powders are supplied toward the multiple peaks in the inner space of the discharge tube 120 from the powder injection unit 140 such that the powders flow in the swirl direction while contacting the microwave torch plasma.

In this process, the powders flow in the swirl direction along the edge of the inner space of the discharge tube 120, and thus come into contact with the high-density edge of the microwave torch plasma.

The flowability of the powders is related to the electrostatic properties of the powder material. When the powders are treated using the powder treating apparatus using the microwave torch plasma having the high edge area density according to one embodiment of the present disclosure, the static electricity of the powder material may be reduced to increase the flowability of the fine powders.

### EXAMPLE

### Treating of Yttria Powders

### 1) Flowability and Tap Density of Yttria Powders Before Plasma-Based Treatment

Flowability (FA) before plasma-based treatment: 0 g/sec
Tap density (TD) before plasma-based treatment: 0.98 g/cc

### 2) Plasma-Based Treatment Conditions of Yttria Powders (According to the Present Disclosure)

Plasma applied power: 8 kW
Plasma discharge gas: Oxygen (25 LPM)
Input powder amount: 119 g/kWh
Particle size distribution of yttria powders: 14±2 μm
   3) Measurement of Flowability and Tap Density of Yttria Powders after Plasma-Based Treatment

FIG. 9 is a graph showing results of measuring a flowability and a tap density of yttria powders after plasma-based treatment thereon using the powder treating apparatus using microwave torch plasma having a high edge area density according to one embodiment of the present disclosure.

FA (flowability) shown in the graph of FIG. 9 is measured by the national standard number KS L 1626 as the flowability evaluation method of fine ceramic powders, and is based on the measurement of an amount of powders flowing out from a standard measuring device per unit time. The TD (tap density) is based on a measurement of the mass per unit volume of powders before and after the plasma-based treatment.

As shown in FIG. 9, the tap density of the yttria powders before the plasma-based treatment according to the powder treating apparatus of the present disclosure was 0.98 g/cc, while the tap density of the yttria powders after the plasma-based treatment increased to 2 g/cc. The flowability of the yttria powders before the plasma-based treatment was 0 g/sec, while the flowability of the yttria powders after the plasma-based treatment increased significantly to 8.62 g/sec.

4) Measurement of Tribocharging Power of Yttria Powders after Plasma-Based Treatment Using Apparatus of the Present Disclosure (Hereinafter, Present Apparatus) and Comparative Apparatus

In this regard, the Comparative apparatus is a powder treating apparatus having a discharge tube vertically extending through a TE₁₀ mode waveguide, a plasma discharge gas injection unit at a side of one end of the discharge tube, and a powder injection unit at a side of the other end of the discharge tube. This Comparative apparatus generates the microwave torch plasma with a high central area density in the discharge tube, and the plasma-based treatment conditions of the yttria powders are as follows.

### <Conditions of Plasma-Based Treatment of Yttria Powders in the Comparative Apparatus>

Plasma applied power: 8 kW
Plasma discharge gas: Oxygen (25 LPM)
Input powder amount: 119 g/kWh
Particle size distribution of yttria powders: 14±2 μm

TABLE 1
Comparison of tribocharging powers of yttria powders after plasma-
based treatment using Present apparatus and Comparative apparatus

| | Average charge | | Max charge | | Charge to mass | |
|---|---|---|---|---|---|---|
| Before plasma- | −78.8 | V | −101.7 | V | −0.688 | V/g |
| based treatment | | | | | | |
| Comparative | 4.1 | V | 43 | V | 0.02 | V/g |
| apparatus | | | | | | |
| Present apparatus | 0.41 | V | 4.3 | V | 0.011 | V/g |

As shown in Table 1, a significant amount of static electricity was generated before the plasma-based treatment. On the other hand, the static electricity was relatively greatly reduced after the plasma-based treatment. This is because the pores and rough edges formed on the surface of the yttria powders particles are filled or partially melted under the plasma-based treatment, and thus, the charges that can migrate decrease as the pores formed on the surface of the powder particles are filled, and the charges on the surface of the powder particles decrease and the frictional force also decreases as the rough edges melt and become spherical. Accordingly, the aggregation between the powder particles is reduced and thus the flowability is improved due to the plasma-based treatment.

Furthermore, as shown in Table 1, it may be identified that the static electricity of the powders are further reduced when the powder treating apparatus of the present disclosure is used, compared to that when Comparative apparatus is used.

5) Observation of Aggregation of Yttria Powders after Plasma-Based Treatment

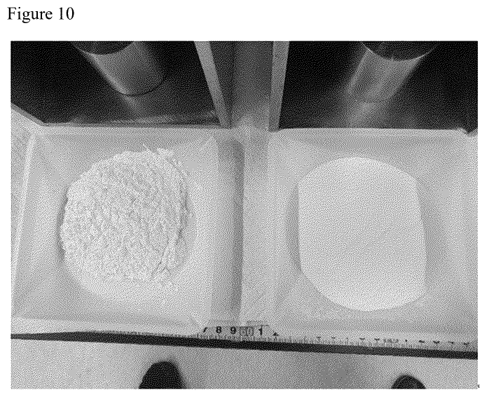

FIG. 10 is a diagram showing aggregation of yttria powders before plasma-based treatment thereon and aggregation of yttria powders after plasma-based treatment thereon using the powder treating apparatus using microwave torch plasma having a high edge area density according to one embodiment of the present disclosure.

As shown in FIG. 10, it is observed that the yttria powders before the plasma-based treatment are clumped or aggregated with each other, while it is difficult to find clumped or aggregated yttria powders after the plasma-based treatment.

When the powder treating apparatus using microwave torch plasma with a high edge area density according to an embodiment of the present disclosure as described above is used, the surface uniformity and flowability of the powders may be increased, and the powders may be efficiently treated while a significant portion of the powder flows smoothly in the swirl direction without being stuck or accumulated on the inner wall of the discharge tube 120.

Furthermore, the waveguide 110 has the width increased so that the electric field distribution having the multiple peaks is generated therein. The discharge tube 120 extends through the waveguide 110 and the diameter of the discharge tube 120 may be increased such that the multiple peaks are positioned within the diameter area thereof, thereby further increasing the plasma density in the edge area of the discharge tube 120, such that the amount of powders which can be treated using the apparatus may be increased.

In one example, the powder treating apparatus using the microwave torch plasma having the high edge area density according to one embodiment of the present disclosure may be include in the plasma spray coating apparatus for plasma spray coating.

The description of the disclosed embodiments is provided to enable a person skilled in the art to make or use the present disclosure. Various modifications to these embodiments will be apparent to one of ordinary skill in the art, and the general principles defined herein may be applied to other embodiments without departing from the scope of the disclosure. Thus, the present disclosure is not intended to be limited to the embodiments presented herein but should be construed in the widest scope consistent with the principles and novel features presented herein.

1. A powder treating apparatus using microwave torch plasma having a high edge area density, the apparatus comprising:
a microwave waveguide, wherein when a dominant mode waveguide for transmitting an electromagnetic wave of a specific frequency is a, the microwave waveguide has a width of na, where n is an integer greater than or equal to 2;
a discharge tube vertically extending through the waveguide such that all of two or more peaks of an electric field distribution within the waveguide are positioned in an inner space of the discharge tube;
a plasma discharge gas injection unit disposed at a side of one end in a vertical direction of the discharge tube and configured to inject the plasma discharge gas into the discharge tube; and
a treatment target powder injection unit disposed at a side of the other end in the vertical direction of the discharge tube and configured to inject the treatment target powder into the discharge tube.

2. The apparatus of claim 1, wherein when the dominant mode waveguide for transmitting the electromagnetic wave of the specific frequency is a, the microwave waveguide has the width of na, wherein n is an integer greater than or equal to 2,
wherein when the electric field distribution along a width direction of the waveguide is (2n)λ/2 where n is an integer greater than or equal to 1, the discharge tube is installed such that a longitudinal null line of the electric field distribution extends through a center of the discharge tube, and adjacent peaks of the electric field distribution are positioned in an inner space of the discharge tube.

3. The apparatus of claim 1, wherein when the dominant mode waveguide for transmitting the electromagnetic wave of the specific frequency is a, the microwave waveguide has the width of na, wherein n is an integer greater than or equal to 2,
wherein when the electric field distribution along a width direction of the waveguide is (2n+1)λ/2 where n is an integer greater than or equal to 1, the discharge tube is installed such that a center of the discharge tube coincides with a central peak among peaks arranged in a longitudinal direction of the waveguide of the electric field distribution.

4. The apparatus of claim 1, wherein the plasma discharge gas injection unit is configured to inject the gas tangentially with respect to a cross-sectional circle of the discharge tube, so that the gas flows in a swirl manner within the discharge tube.

5. The apparatus of claim 4, wherein the treatment target powder injection unit is configured to inject the powders in the same direction as the injection direction of the gas in the swirl manner.

6. The apparatus of claim 5, wherein the treatment target powder injection unit is configured to inject the powders toward the peak of the electric field distribution.

7. The apparatus of claim 6, wherein the treatment target powder injection unit includes at least two treatment target powder injection units,
wherein the at least two treatment target powder injection units respectively inject the powders toward at least two peaks of the electric field distribution.

8. The apparatus of claim 6, wherein the powder treating apparatus further include a straight gas injection unit configured to inject straight gas into the discharge tube in a direction from the plasma discharge gas injection unit to the treatment target powder injection unit along a central axis of the discharge tube.

9. A plasma spray coating apparatus including the powder treating apparatus of claim 1.
